(19) United States
(12) Patent Application Publication
(10) Pub. No.: US 2020/0247545 A1
(43) Pub. Date: Aug. 6, 2020

(54) Passenger Cabin For A Vehicle And A Vehicle Comprising At Least One Cabin Of This Kind

(71) Applicant: Airbus Operations GmbH, Hamburg (DE)

(72) Inventors: Lars Vollers, Hamburg (DE); Axel Dengler, Hamburg (DE); Magnus Averbeck, Hamburg (DE); Tobias-Valentin Mayer, Hamburg (DE)

(73) Assignee: Airbus Operations GmbH, Hamburg (DE)

(21) Appl. No.: 16/750,374

(22) Filed: Jan. 23, 2020

(30) Foreign Application Priority Data
Jan. 31, 2019 (DE) 10 2019 102 476.5

(51) Int. Cl. B64D 11/06; B64D 11/00; B64C 1/18; B64C 1/00; B64C 1/22

(52) U.S. Cl. CPC B64D 11/0601; B64D 11/00; B64D 11/003; B64C 2001/0027; B64C 1/00; B64C 1/22; B64D 2011/0046; B64C 1/18

(57) ABSTRACT

A passenger cabin for a vehicle has an upper passenger deck with an upper arrangement of seats, a lower passenger deck with a lower arrangement of seats, an upper floor for the upper passenger deck arranged between the upper passenger deck and the lower passenger deck, and a lower floor for the lower passenger deck delimiting the lower passenger deck. The upper floor has a central hump region extending along a longitudinal axis of the passenger cabin at least in regions and above which the upper arrangement of seats is arranged, and two side regions adjacent to the hump region. The central hump region is raised relative to the side regions. The lower floor has a lower gangway, wherein the at least one lower arrangement of seats is arranged below the side regions of the upper floor, and the lower gangway is arranged below the central hump region.

### FIELD OF THE INVENTION

The invention relates to a passenger cabin for a vehicle and to a vehicle comprising at least one cabin of this kind.

### BACKGROUND OF THE INVENTION

A passenger cabin of a vehicle can be of single- or multi-storey design. Multi-storey passenger cabins are known in virtually all known vehicles.

One objective when designing a vehicle for transporting passengers is implementation in as economical a manner as possible, that is to say a cost-benefit ratio which is as optimal as possible. This can be achieved by way of as high a number of passenger seats as possible being implemented, while the dimensions are as compact as possible at the same time. Further boundary conditions are particularly important depending on the type of vehicle. For example, the weight should be as low as possible in the case of commercial aircraft. Furthermore, an area which is subject to flow should be as small as possible in order to implement an air resistance which is as low as possible. In the case of commercial aircraft with a round fuselage cross section, this could have a particular effect on minimizing the fuselage diameter.

DE 10 2012 005 148 A1 discloses, for example, a passenger cabin for aircraft, in which passenger cabin there are two passenger decks which are arranged one above the other and one has a non-mirror-symmetrical arrangement of seats. The floors of the passenger decks which are situated one above the other are bent several times and have different individual seats and benches.

### BRIEF SUMMARY OF THE INVENTION

An aspect of the invention relates to an alternative passenger cabin for a vehicle, which passenger cabin has dimensions which are as compact as possible and leads to utilization of the available installation space in as advantageous a manner as possible.

An aspect of the invention proposes a passenger cabin for a vehicle, having an upper passenger deck with at least one upper arrangement of seats, a lower passenger deck with at least one lower arrangement of seats, an upper floor for the upper passenger deck, which upper floor is arranged between the upper passenger deck and the lower passenger deck, and a lower floor for the lower passenger deck, which lower floor delimits the lower passenger deck, wherein the upper floor has a central hump region, which extends along a longitudinal axis of the passenger cabin at least in regions and above which the at least one upper arrangement of seats is arranged, and two side regions which are adjacent to the said hump region, wherein the central hump region is raised relative to the side regions, wherein the lower floor has a lower gangway, wherein the at least one lower arrangement of seats is arranged below the side regions of the upper floor, and wherein the lower gangway is arranged below the central hump region.

The upper floor has a central hump region above which the at least one upper arrangement of seats is arranged. The hump region is a region of the upper floor which extends or arches vertically upwards from a planar basic form. The hump region can run parallel in relation to a longitudinal direction of the passenger cabin and extend over relatively long sections of the passenger cabin.

The lower gangway, which is provided on the lower floor and is arranged directly below the central hump region, serves for passage through the lower passenger deck. Owing to the direct arrangement beneath the central hump region, a passenger moving along the gangway is provided with a greater height than in adjacent, lateral regions of the lower passenger deck. A distance between an upper edge of the lower floor and a lower edge of the central hump region should therefore be dimensioned in such a way that a passenger can move along the lower gangway without any trouble.

The thickness of the hump of the central hump region could be dimensioned in such a way that it corresponds approximately to the height of a seat chassis for conventional passenger seats. The sitting surfaces could then be arranged largely directly on the central hump region or the seat chassis could have a lower height than conventional seat chassis or be designed as a seat frame for the sitting surface. Furthermore, at least one seat rail, which serves to receive the seats, could be arranged on the hump. Accordingly, sitting surfaces, seat frames or flat seat chassis could be fastened onto the seat rail. Furthermore, suitable, correspondingly shaped fastening apparatuses or fittings could be used for this purpose.

An arrangement of the central hump region directly along a centre axis of the passenger cabin additionally results in a maximum clear height above the lower floor, particularly in the case of round fuselage cross sections. Accordingly, in the case of the refinement as defined here, a fuselage diameter can be implemented which is situated below conventional fuselage diameters for cabins with dual gangways. A fuselage diameter could lie, for example, below 4.6 m.

In addition, side regions of the fuselage could be used, in particular, for secondary assemblies, such as storage compartments for hand luggage for example. This results in very good utilization of a fuselage cross section and accordingly the ability, in principle, to reduce the fuselage diameter. The construction of the passenger cabin can extend over relatively large sections of length of the aircraft fuselage. As a result, short-haul aircraft with a low cargo space requirement, which are particularly economical, can be produced in particular.

In an advantageous embodiment, the at least one upper arrangement of seats has a plurality of upper seats which are arranged directly on the hump region. The use of a plurality of seats in the at least one upper arrangement consequently leads to improved utilization of the installation space owing to a relatively high seating density. For example, two or three passenger seats, each with the same orientation, can be arranged next to one another, instead of one single seat in each case.

The upper seats each particularly preferably prespecify a seat direction which runs diagonally in relation to the longitudinal axis. Owing to the diagonal arrangement and therefore a diagonal seat direction relative to the longitudinal axis of the cabin, utilization of the installation space can be further improved by way of it being possible to provide larger distances at the sides, in particular in the shoulder region of the passengers.

The seat direction of the upper seats preferably forms an angle with the longitudinal axis that lies in a range of from 5 to 45°. Owing to an angular range which is dimensioned in this way, the sense of comfort remains largely uninfluenced, but a higher seating density can nevertheless be provided.

In a further advantageous embodiment, the at least one upper arrangement of seats has first rows of seats comprising a plurality of seats and second rows of seats comprising a plurality of seats, wherein first rows of seats and second rows of seats are arranged alternately on the hump region, wherein the seats of the first rows of seats prespecify seat directions in relation to the longitudinal axis that differ from the seat directions of the seats of the second rows of seats. In addition to the previously mentioned advantages of optimal utilization of the installation space, the alternating arrangement of the first and second rows of seats allows access to the laterally adjacent regions as well as a symmetrical weight distribution.

The side regions each particularly preferably have an upper gangway. The side regions can have the greatest clear height and are therefore each suitable for incorporating an upper gangway in particular. The said upper gangway could be delimited between assemblies which are situated laterally on the outside and the first seats which are arranged in the centre.

It is advantageous when the side regions have upper storage compartments which are situated laterally on the outside and are arranged on the upper floor. Since the side regions have only a very low clear height laterally on the outside, they are particularly suitable for incorporating storage compartments. In addition, particularly ergonomic handling of hand luggage is rendered possible since it is not necessary to lift up the said hand luggage to an overhead storage compartment.

In addition, lower storage compartments which are situated laterally on the outside could also be arranged on a bottom side of the upper floor. The said lower storage compartments are therefore provided above and behind the second seats and can be used, in particular, for small, lightweight luggage.

The clear height between a top side of the lower gangway and a bottom side of the hump region preferably corresponds to at least 1.95 m. The preferred height can be determined in accordance with different standards in which human body sizes are classified. The said body sizes are based on anthropometric investigations with which the fifth and the ninety-fifth percentile are ascertained as statistical extreme values for the technical configuration. This means that only 5% (5^{th} percentile) are smaller than anticipated and, respectively, only 5% are larger than anticipated (95^{th} percentile).

The passenger cabin preferably additionally has an axial section which has an upper passenger deck and a cargo space which is situated beneath the said passenger deck, wherein an upper floor of this axial section is lower than the upper floor of an axial section which adjoins the first-mentioned upper floor and in which an upper passenger deck and a lower passenger deck are arranged. As already mentioned above, it may be appropriate to not equip parts of a passenger cabin with two compact passenger decks which are situated one above the other if the available installation space does not allow this. This could relate, for example, to an axial region which is arranged behind a wingbox or the like.

The invention further relates to an aircraft having an aircraft fuselage with a passenger cabin according to the preceding description which is arranged in the said aircraft fuselage.

In this case, the upper floor can be designed in the form of module components.

Owing to the module components, these module components can also be integrated into the aircraft in different numbers, depending on the requirements of the aircraft operator, during the production of an aircraft.

An axial section, which is arranged above a wingbox, can be equipped with a passenger cabin which has a floor which is situated vertically below the upper floor. In this way, regions of the aircraft in which the existing installation space is insufficient to provide the passenger cabin presented above which has an upper and a lower passenger deck are taken into account in particular. There can also be a plurality of regions of this kind. There can also be ramp-like areas, which connect the two regions of the aircraft to one another, between one floor and an upper floor and also a lower floor.

### BRIEF DESCRIPTION OF THE DRAWINGS

Further features, advantages and possible uses of the present invention can be found in the following description of the exemplary embodiments and the figures. Here, all the features described and/or illustrated in the figures form the subject matter of the invention individually and in any desired combination, even irrespective of how they are combined in the individual claims or the dependency references thereof. Furthermore, in the figures, identical reference signs denote identical or similar objects.

FIG. 1 shows a sectional view through a first exemplary embodiment of a passenger cabin in an aircraft fuselage.

FIG. 2 shows a sectional view through a further exemplary embodiment of a passenger cabin in the aircraft fuselage.

FIG. 3 shows a sectional view through an additional section in a passenger cabin.

FIG. 4 shows a three-dimensional illustration of an aircraft with a passenger cabin which is integrated into the said aircraft.

### DETAILED DESCRIPTION

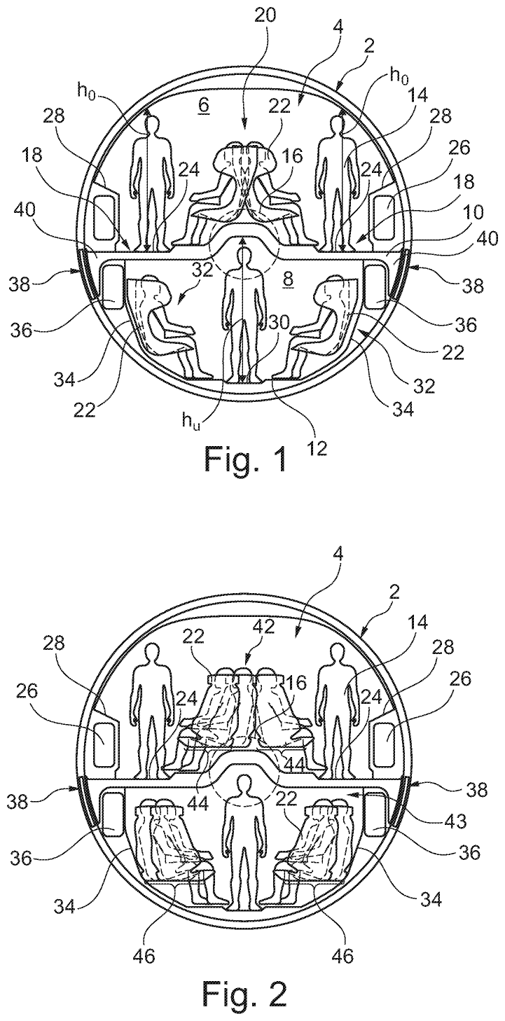

FIG. 1 shows a cross-section through an aircraft fuselage 2 with a passenger cabin 4 which is arranged in the said aircraft fuselage. The passenger cabin has an upper passenger deck 6 and a lower passenger deck 8. An upper floor 10 is arranged between the upper passenger deck 6 and the lower passenger deck 8. The lower passenger deck 8 is delimited at the bottom by a lower floor 12. Both passenger decks 6 and 8 are designed to hold several passengers 14.

The upper floor 10 has a central hump region 16 which extends along a longitudinal axis x (see FIG. 4) of the passenger cabin 4 at least in regions. The hump region is distinguished in that it is raised relative to adjacent, side regions 18, that is to say is offset upwards in the vertical direction. An upper arrangement 20 of passenger seats 22 is located on the hump region 16. The exemplary embodiment illustrated in FIG. 1 is designed in such a way that a conventional seat chassis is largely dispensed with from the passenger seats 22 and the passenger seats 22 are fastened on the hump region 16 only by means of flanges and fastening elements, not shown in any detail here.

The side regions 18 each have an upper gangway 24. Since the upper floor 10 with the side regions 18 is located approximately at half the height of the aircraft fuselage 2, the height hₒ which is provided by the upper gangways 24 can correspond to the customary standards in respect of body sizes to be taken into account, for example the 95^{th} percentile, in the case of a fuselage diameter of approximately 4.5 m (or somewhat less or somewhat more).

On account of the curvature of the fuselage 2, the upper gangways 24 should be arranged as close as possible to the central hump region 16 in order to provide a sufficient clear height hₒ. Regions of the upper passenger deck 6 which are situated laterally on the outside are therefore very highly suitable for incorporating upper storage compartments 26 in which passengers 14 can store hand luggage. An upper gangway 24 is also defined between the central hump region 16 and the storage compartments 26.

The upper arrangement 20 of passenger seats 22 is designed in such a way that, by way of example, seats with different seat directions alternately follow one another along the longitudinal axis x of the fuselage 2. A seat direction, which substantially coincides with the viewing direction of a passenger 14 sitting straight in the passenger seat 22 in question, in each case forms an angle, which is different from zero, with the longitudinal axis x of the fuselage 2. The said angle can lie, by way of example, between 5 and 45°. Therefore, passengers look diagonally forwards, wherein, in the case of the design shown, the individual passengers 14 look alternately forwards and to the right and, respectively, forwards and to the left. Owing to the staggered arrangement of passenger seats 22, the space on the central hump region 16 can be employed in as advantageous a manner as possible, wherein sufficient freedom of movement for the passengers 14 is rendered possible at the same time.

The storage compartments 26 can be made accessible, in particular, by an upper flap 28 in each case. The flap 28 could be pivoted open in the direction of the respective upper gangway 24 or laterally to the outside. Hand luggage could then be inserted into, or removed from, the respective storage compartment 26 from above. As an alternative, flaps or doors which are each directed to an upper gangway 24 are also conceivable.

In comparison, the lower passenger deck 8 has a single, lower gangway 30. The said lower gangway is located directly below the hump region 16 and likewise extends along the longitudinal axis x of the aircraft fuselage 2. Two lower arrangements 32 of seats 22 are arranged to the sides of the said lower gangway. The said lower arrangements of seats are located, by way of example, on a side wall 34 of the lower passenger deck 8, so that a seat chassis could likewise be dispensed with. However, it is possible for the passenger seats 22 to instead also be fastened on the floor by means which are not illustrated.

In the case shown, the side walls 34 include lateral, lower storage compartments 36 which are positioned approximately level with a headrest of the passenger seats 22 of the lower arrangements 32. A lower clear height hᵤ between a top side of the lower gangway 30 and the bottom side of the hump region 16 can be dimensioned just like the upper height hₒ.

The passenger seats 22 of the lower arrangements 32 can likewise have a seat direction which is arranged diagonally in relation to the longitudinal axis x of the fuselage 2. The seats 22 of the left-hand lateral half of the lower passenger deck 8 correspond, in terms of their orientation, to the seats 22 of the upper passenger deck 6 which face towards the right, while the seats 22 of the right-hand lateral half of the lower passenger deck 8 correspond, in terms of their orientation, to the seats 22 of the upper passenger deck 6 which face towards the left.

The upper floor 10 can be designed as a rigid module which can be connected to the fuselage 2 by means of mechanical interfaces 38. By way of example, a cantilever 40 which extends largely vertically downwards from the floor is used for this purpose. The cantilever 40 serves both to increase the stability of the floor 10 itself and also to increase the size of the support area of the floor 10 on the fuselage 2 or a structure which forms the fuselage 2. Owing to the modular configuration, the fuselage 2 can be equipped with different passenger cabins 4 in places, which passenger cabins have two passenger decks 6 and 8 or only one single passenger deck and a cargo space which is situated beneath the said passenger deck.

Whereas FIG. 1 proposes relatively generous seating, FIG. 2 shows an alternative with an upper arrangement 42 of passenger seats 22 in which a plurality of passenger seats 22 are respectively combined to form a row 44 of seats which, like the individual passenger seats 22 in FIG. 1, are alternately arranged diagonally in the direction of both sides. In order to increase the storage compartment volume, it would furthermore be conceivable to provide an upper, central storage compartment, not illustrated here, above the upper arrangement 42.

In the lower passenger deck 8, two passenger seats 22 are likewise respectively combined to form a row 46 of seats and arranged on the side walls 34 in a lower arrangement 43. In this way, the two passenger decks 6 and 8 are equipped with relatively dense seating.

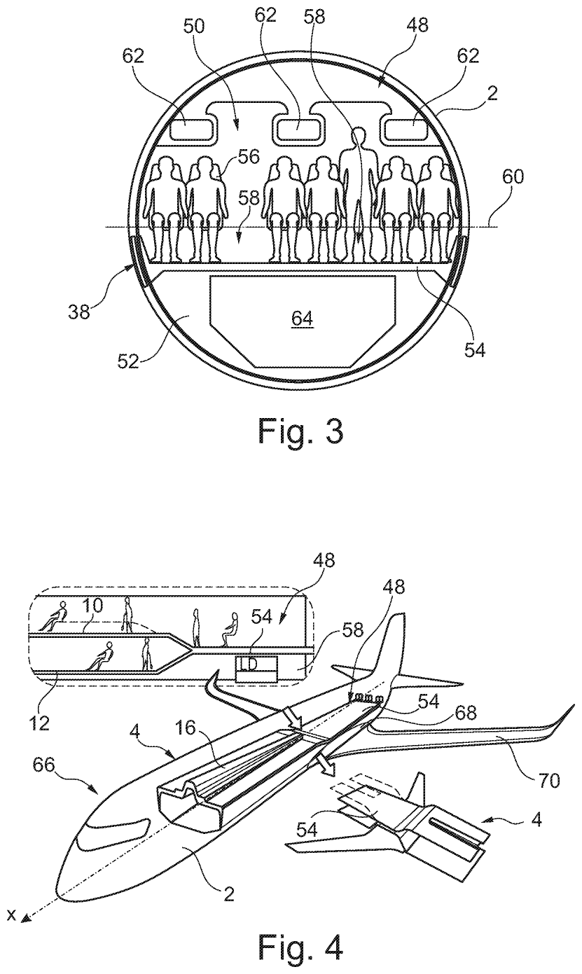

FIG. 3 shows an additional axial section 48 which has a single passenger deck 50 and a cargo space 52 which is situated beneath the said passenger deck. As mentioned above, a passenger cabin with two passenger decks which are situated one above the other can be prevented by structural restrictions from being implemented in certain regions of an aircraft. It may also be desirable to use an alternative passenger cabin in certain sections of the aircraft. In this case, it may be expedient to implement the variant shown in FIG. 3.

The said figure shows a floor 54 which delimits the passenger deck 50 at the bottom and is likewise designed as a module component. In comparison to the upper floor 10 from the previous illustrations, the floor 54 shown here is substantially planar. In addition, the said floor is located in an installation position which is situated vertically below the upper floor 10. Fastening of the floor 54 can be carried out, in the same way as that of the upper floor 10, by way of mechanical interfaces 38 being connected to the fuselage 2.

The passenger deck 50 can have a plurality of passenger seats 56 which are arranged, merely by way of example, to form rows of in each case six passenger seats 56 which are separated from one another by two gangways 58. Therefore, two passenger seats 56 are in each case situated laterally on the outside, while two seats 56 are arranged centrally between the gangways 58. Although the fuselage diameter is restricted to approximately 4.6 m, 4.5 m or less, a comfortable arrangement with a generous provision of space can nevertheless be achieved, in particular, owing to the deeper-lying floor 54 somewhat below the centre line 60 in the vertical direction of the fuselage. The height of the floor 54 can be matched to a required height of the cargo space 52 which should be suitable for holding air cargo containers 64.

Storage compartments 62 for holding hand luggage can be arranged above the seats 56. The storage compartments 62 directly above the two central seats 56 can correspond, in terms of their size, to the storage compartments 62 which are situated laterally on the outside.

Finally, FIG. 4 shows an aircraft 66 which has the aircraft fuselage 2, described above, in which the passenger cabin 4 is arranged. The fuselage 2 can have a wingbox 68 by way of which the wings 70 of the aircraft 66 are mechanically connected to the fuselage 2. In this and further regions of the fuselage 2 which adjoin the said fuselage, it is expedient to dispense with the subdivision into an upper passenger deck 6 and a lower passenger deck 8. The single passenger deck 48 from FIG. 3 could be provided here. It is clear that the floor 54 is arranged deeper than the upper floor 10. As a result, the passenger deck 50 of this additional section can be configured like a conventional passenger deck of a customary commercial aeroplane, while the cargo space 52 can be implemented at least behind the wingbox 68 below the floor 54.

In addition, it should be noted that “having” does not rule out any other elements or steps, and “a” or “an” do not rule out a multiplicity. It should further be noted that features which have been described with reference to one of the above exemplary embodiments may also be used in combination with other features of other exemplary embodiments described above. Reference symbols in the claims are not to be regarded as limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE SYMBOLS

2 Aircraft fuselage
4 Passenger cabin
6 Upper passenger deck
8 Lower passenger deck
10 Upper floor
12 Lower floor
14 Passenger
16 Central hump region
18 Side region
20 Upper arrangement of passenger seats
22 Seat, passenger seat
24 Upper gangway
26 Upper storage compartment
28 Upper flap
30 Lower gangway
32 Lower arrangement of passenger seats
34 Side wall
36 Lateral, lower storage compartment
38 Mechanical interface
40 Cantilever
42 Upper arrangement of passenger seats
43 Lower arrangement of passenger seats
44 Row of seats
46 Row of seats
48 Additional axial section
50 Single passenger deck
52 Cargo space
54 Floor
56 Passenger seat
58 Gangway
60 Centre line
62 Storage compartment
64 Air cargo container
66 Aircraft
68 Wingbox
70 Wing
hₒ Upper clear height
hᵤ Lower clear height

1. A passenger cabin for a vehicle, comprising:
an upper passenger deck with at least one upper arrangement of seats;
a lower passenger deck with at least one lower arrangement of seats;
an upper floor for the upper passenger deck, wherein the upper floor is arranged between the upper passenger deck and the lower passenger deck; and
a lower floor for the lower passenger deck, wherein the lower floor delimits the lower passenger deck,
wherein the upper floor has a central hump region extending along a longitudinal axis of the passenger cabin at least in regions and above the central hump region the at least one upper arrangement of seats is arranged, and two side regions adjacent to the hump region,
wherein the central hump region is raised relative to the two side regions,
wherein the lower floor has a lower gangway,
wherein the at least one lower arrangement of seats is arranged below the two side regions of the upper floor, and
wherein the lower gangway is arranged below the central hump region.

2. The passenger cabin according to claim 1, wherein the at least one upper arrangement of seats has a plurality of upper seats arranged directly on the hump region.

3. The passenger cabin according to claim 2, wherein the upper seats each prespecify a seat direction which runs diagonally in relation to the longitudinal axis.

4. The passenger cabin according to claim 3, wherein the seat direction of the upper seats forms an angle with the longitudinal axis that lies in a range of from 5 to 45°.

5. The passenger cabin according to claim 1,
wherein the at least one upper arrangement of seats has first rows of seats comprising a plurality of seats and second rows of seats comprising a plurality of seats, wherein first rows of seats and second rows of seats are arranged alternately on the hump region,
wherein the seats of the first rows of seats prespecify seat directions in relation to the longitudinal axis that differ from the seat directions of the seats of the second rows of seats.

6. The passenger cabin according to claim 1, wherein the two side regions each have an upper gangway.

7. The passenger cabin according to claim 1, wherein the two side regions have upper storage compartments situated laterally on the outside and arranged on the upper floor.

8. The passenger cabin according to claim 1, wherein lower storage compartments situated laterally on the outside are arranged on a bottom side of the upper floor.

9. The passenger cabin according to claim 1, wherein a lower clear height between a top side of the lower gangway and a bottom side of the hump region is at least 1.95 m.

10. The passenger cabin according to claim 1,
wherein the passenger cabin additionally has an axial section which has a single passenger deck and a cargo space situated beneath the passenger deck,
wherein a floor of the passenger deck of the additional axial section is lower than the upper floor of an axial section adjoining the floor of the passenger deck of the additional axial section and the upper passenger deck and the lower passenger deck are arranged.

11. An aircraft, comprising: an aircraft fuselage with a passenger cabin according to claim 1 arranged in the aircraft fuselage.

12. The aircraft according to claim 11, wherein the upper floor is configured in the form of module components.

13. The aircraft according to claim 11, wherein a floor situated vertically below the upper floor, is arranged in an additional axial section arranged above a wingbox.
